(19) United States
(12) Patent Application Publication
(10) Pub. No.: US 2015/0254881 A1
(43) Pub. Date: Sep. 10, 2015

(54) INFORMATION PROCESSING METHOD AND ELECTRONIC DEVICE

(71) Applicants: Beijing Lenovo Software Ltd., Beijing (CN); Lenovo (Beijing) Co., Ltd., Beijing (CN)

(72) Inventors: Yong Duan, Beijing (CN); Xiang Cao, Beijing (CN); Liuxin Zhang, Beijing (CN)

(21) Appl. No.: 14/499,684

(22) Filed: Sep. 29, 2014

(30) Foreign Application Priority Data
Mar. 10, 2014 (CN) 201410086344.9
Jun. 23, 2014 (CN) 201410283636.1

(51) Int. Cl. G06T 11/40; G06T 11/20

(52) U.S. Cl. CPC G06T 11/40; G06T 11/20

(57) ABSTRACT

A method for processing information and an electronic device are provided. The method includes: obtaining parameter information of an operator located in the front of a mirror display screen by using an image acquisition apparatus; calculating a first digital image matching with a virtual image of the operator based on the parameter information by using a predetermined algorithm; and determining a first instruction corresponding to a first input operation performed by the operator.

### CROSS-REFERENCES TO RELATED APPLICATIONS

The present application claims priority to Chinese Patent Application No. 201410086344.9, entitled “METHOD FOR PROCESSING INFORMATION AND ELECTRONIC DEVICE”, filed with the Chinese State Intellectual Property Office on Mar. 10, 2014, and priority to Chinese Patent Application No. 201410283636.1, entitled “METHOD FOR PROCESSING INFORMATION AND ELECTRONIC DEVICE”, field with the Chinese State Intellectual Property Office on Jun. 23, 2014, which are incorporated herein by reference in their entireties.

### BACKGROUND

1. Technical Field

The disclosure relates to the field of electronic technology, and particularly to an information processing method and an electronic device.

2. Related Art

A mirror is one of the common commodities in life. An image in the mirror is formed by an interaction point of the extension lines of the reflected rays of light, and hence the image in the mirror is a virtual image. The virtual image has the same size as the corresponding object, and the distance from the virtual image to the mirror is equal to the distance from the corresponding object to the mirror. Therefore the image and the corresponding object arte symmetrical with respect to the mirror. The mirror may present a virtual image of an environment in front of the mirror.

Among the electronic devices in present life and work, some electronic devices have a display screen, for example a computer, a mobile phone or a smart watch. The display screen displays a content to be displayed for a user by an electro or a liquid crystal molecule, based on a display control instruction from the electronic device.

However, in the related art, an electronic device combining a mirror with a display screen together does not exist.

### SUMMARY

According to the embodiments of the present disclosure, it is provided a method for processing information and an electronic device, to solve the above issue.

In an aspect, it is provided a method for processing information, which includes: obtaining parameter information of an operator located in the front of a mirror display screen by using an image acquisition apparatus; calculating a first digital image matching with a virtual image of the operator based on the parameter information by using a predetermined algorithm; and determining, based on the first digital image, a first instruction corresponding to a first input operation performed by the operator.

In another aspect, it is provided an electronic device, which includes a mirror display screen; a first obtaining unit, configured to obtain parameter information of an operator located in the front of the display screen by using an image acquisition apparatus; a second obtaining unit, configured to calculate a first digital image matching with a virtual image of the operator based on the parameter information by using a predetermined algorithm; and a determining unit, configured to determine a first instruction corresponding to a first input operation performed by the operator based on the first digital image.

### BRIEF DESCRIPTION OF THE DRAWINGS

FIG. 1 is a flow diagram of a method for processing information according to an embodiment of the disclosure;

FIG. 2 is a schematic diagram of a predetermined algorithm according to an embodiment of the disclosure;

FIG. 3 is a schematic diagram of a first display content according to an embodiment of the disclosure;

FIG. 4 is a schematic diagram of a second display content according to an embodiment of the disclosure;

FIG. 5 is a schematic diagram of a first part of a first digital image according to an embodiment of the disclosure;

FIG. 6 is a schematic diagram of a first part of another first digital image according to an embodiment of the disclosure;

FIG. 7 is a schematic structural diagram of an electronic device according to another embodiment of the disclosure;

FIG. 8 is a schematic structural diagram of another electronic device according to another embodiment of the disclosure;

FIG. 9 is flow diagram of anther method for processing information according to an embodiment of the disclosure;

FIG. 10A and FIG. 10B are schematic diagrams showing a mirror image effect when an observer view at two positions according to an embodiment of the disclosure;

FIG. 11 is a schematic diagram of a three dimensional coordinate system of a depth camera and a three dimensional coordinate system of a virtual image space according to an embodiment of the disclosure;

FIG. 12 is a schematic diagram of a display effect for displaying a constructed cup on a display screen according to an embodiment of the disclosure;

FIG. 13 is a schematic diagram of a principle for determining N display positions according to an embodiment of the disclosure;

FIG. 14A and FIG. 14B are schematic diagrams of a display effect for displaying a constructed cube on the display screen according to an embodiment of the disclosure;

FIG. 15 is a schematic diagram of a display effect for displaying a constructed sofa on the display screen according to an embodiment of the disclosure;

FIG. 16 is schematic position diagram showing that an observer views a display effect at different positions according to an embodiment of the disclosure; and

FIG. 17A to FIG. 17C are schematic diagrams of a display effect for displaying a constructed wall clock on the display screen according to an embodiment of the disclosure.

### DETAILED DESCRIPTION

When a mirror display screen is used by a user, the user can view his/her operation action such as lifting his/her arm or making a click in the front of the mirror display screen by his/her right index finger. Therefore, when content is displayed on the mirror display screen, the user can view that his/her operation action seems to be corresponding to the content. For example, the user can view that an icon “music” displayed on the screen is clicked by a virtual image of a finger of the user. However, in the related art, in the case that the user needs to click the icon “music”, this can only be realized by using a mouse or touching the icon, and can not be realized by remotely inputting a corresponding operation. Therefore, in the related art, a remote interaction between an electronic device in including a mirror display screen and a user is not realized.

In order to solve the technical problem described above, a method for processing information is provided in the embodiments of the present application. The method is applicable to an electric device including a display screen with a mirror effect and an image acquisition apparatus. When an operator of the electronic device is located in the front of the display screen, a first virtual image symmetrical to the operator is displayed by the mirror effect of the display screen. the method may includes:

obtaining parameter information of the operator located in the front of the display screen by using the image acquisition apparatus, where the parameter information is used to construct a first digital image corresponding to the operator located in the front of the display screen;

performing a calculation using a predetermined algorithm on the parameter information to obtain a first digital image, where the first digital image is used to determine an input operation of the operator, and the first digital image matches with the first virtual image; and

determining, based on the first digital image, a first instruction corresponding to a first input operation when the operator performs the first input operation, and presenting an action of the operator for performing the first input operation by the first virtual image.

In the technical solution of the disclosure, firstly, the parameter information of the operator located in the front of the display screen is acquired by using the image acquisition apparatus, the parameter information is used to construct a first digital image corresponding to the operator located in the front of the display screen; a calculation is performed on the parameter information based on a predetermined algorithm to obtain a first digital image, where the first digital image is used to determine the input operation of the operator, and the first digital image matches with the first virtual image; then, when a first input operation is performed by the operator, the first instruction corresponding to the first input operation is determined based on the first digital image, and the action of the operator for performing the first input operation is presented by the first virtual image. In this way, the technical problem in the related art that a remote interaction between an electronic device including a mirror display screen and a user is not realized is solved. And the technical effect that the user is able to perform remote interaction with the electronic device is realized by constructing the first digital image to determine the first input operation of the user once the parameter information is obtained by the image acquisition apparatus.

The technical solution of the disclosure is illustrated in detail below by drawings and the embodiments, it should be understood that the embodiments of the disclosure and specific features in the embodiments are intended to illustrate the technical solution of the disclosure in detail, and are not intended to limit the technical solution of the disclosure, the embodiments of the disclosure and the technical features in the embodiments may be combined with each other without conflicting with each other.

In the embodiments of the disclosure, a method for processing information and an electronic device are provided. In a specific embodiment, the electronic device has a mirror display screen and an image acquisition apparatus, and may be a smart phone, or may also be a notebook computer or a desktop computer. In the embodiments of the disclosure, the electronic device is not limited. In the following description, the method for processing information and the electronic device are described in detail by taking the notebook computer as an example.

### First Embodiment

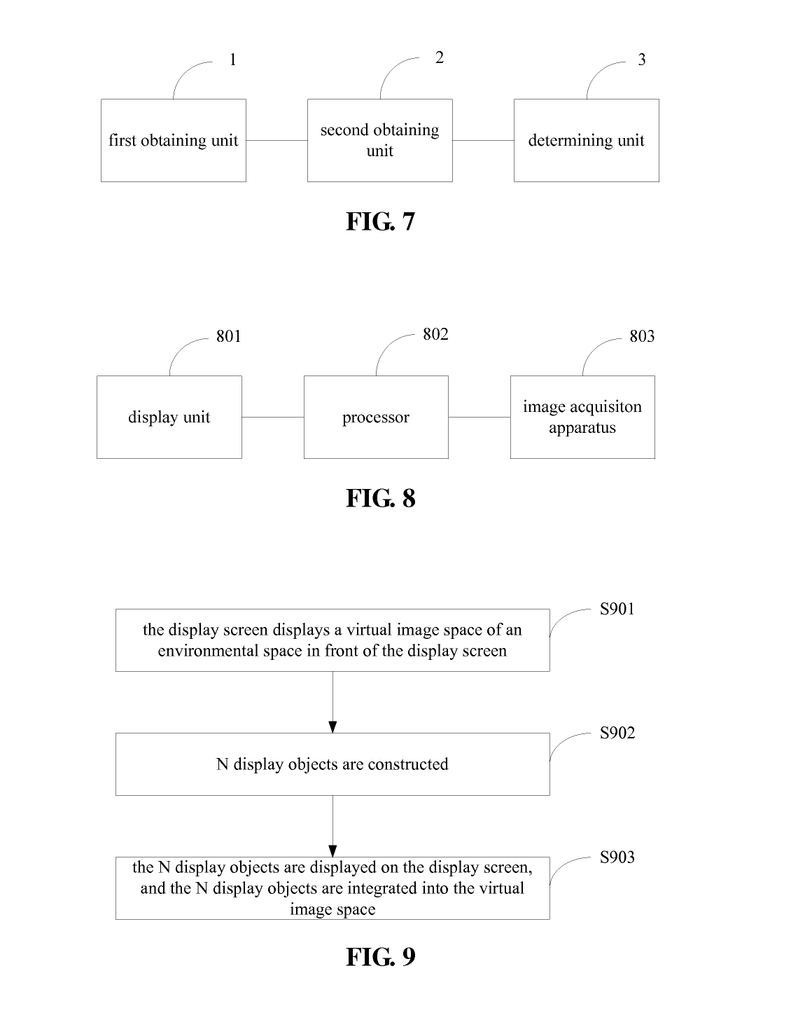

Before introducing a method for processing information according to the embodiment of the disclosure, a basic structure of an electronic device to which the method according to the embodiment of the disclosure is applied is introduced. The electronic device in the embodiment of the disclosure includes a display screen having a mirror effect, that is, a first virtual image of an operator can be displayed on the display screen by the physical property of the display screen, regardless whether the display screen is powered up, it may be known from an optical principle that the first virtual image is symmetrical to the operator with respect to the surface of the display screen. In addition, the electronic device in the embodiment of the disclosure further has an image acquisition apparatus. With reference to FIG. 7, the electronic device in the embodiment of the disclosure further includes:

a first obtaining unit 1, configured to obtain parameter information of the operator located in the front of the display screen by using the image acquisition apparatus, where the parameter information is used to construct a first digital image corresponding to the operator located in the front of the display screen;

a second obtaining unit 2, configured to perform a calculation using a predetermined algorithm on the parameter information to obtain a first digital image, where the first digital image is used to determine an input operation of the operator, and the first digital image matches with the first virtual image; and

a determining unit 3, configured to determine a first instruction corresponding to a first input operation based on the first digital image when the operator performs the first input operation, and present an action of the operator for performing the first input operation by the first virtual image.

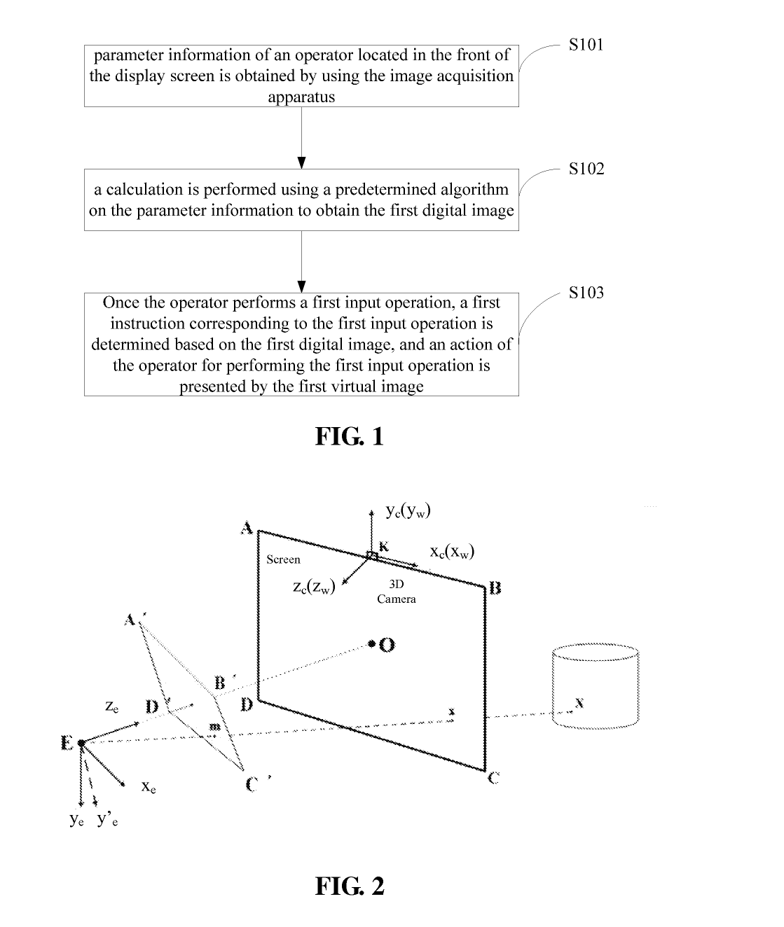

A method for processing information in the disclosure is introduced in detail below with reference to FIG. 1, the method includes steps S101 to S103.

In step S101, parameter information of an operator located in the front of the display screen is obtained by using the image acquisition apparatus.

In the embodiment of the disclosure, in order to determine an input operation of the operator, the parameter information of the input operation is obtained firstly. Specifically, the process of obtaining the parameter information in step S101 is to obtain at least one frame image of the operator located in the front of the display screen by the image acquisition apparatus, and to extract the parameter information required in the at least one frame image.

In real life, when moving the body or turning the head that, although the virtual image of a physical object in the mirror is symmetrical to the physical object, the virtual image viewed by the user in the mirror changes since a viewpoint of the person changes. Therefore, in order to accurately determine the input operation of the user, it is required to know an angle of view of the user. The first digital image may be constructed once parameter information on the angle of view of the user is acquired.

Specifically, in the embodiment of the disclosure, the at least one frame image is acquired by the image acquisition apparatus, a position of eyes of the user is acquired by the face recognition technology, the human eye recognition technology or the like on the at least one frame image, a position of the viewpoint of the human eye is obtained. Specifically, the method for acquiring in the image the position of the human eye is introduced in detail in the related art, which is therefore not described here in the disclosure any more.

In step S102, a calculation is performed using a predetermined algorithm on the parameter information to obtain the first digital image.

After the parameter information is obtained in step S101, the first digital image is obtained by performing the predetermined algorithm on the parameter information. Specifically, in the embodiment of the disclosure, step S102 may include:

obtaining at least one first coordinate of a display content on the display screen in an eye coordinate system based on the parameter information;

obtaining information on a first position of eyes of a user based on the parameter information; and

performing a first calculation based on the information of the first position and the at least one first coordinate, to obtain the first digital image.

Specifically assumed that the human eye is a camera or an image acquisition apparatus, a coordinate system corresponding to the human eye is the eye coordinate system. At least one first coordinate of the display content in the eye coordinate system are acquired firstly based on the parameter information. That is, coordinates of each point in the display content in the eye coordinate system are obtained firstly. Then, information on the first position of eyes of the user is obtained from the parameter information, since the information on the first position determines a final image viewed by the human eye for the same object. In the end, the first digital image is obtained by the first calculation based on the information on a first position and the at least one first coordinate.

Also, the performing the first calculation on the information on a first position and the at least one first coordinate to acquire the first digital image includes:

constructing a homography of the coordinate system of the display screen corresponding to the eye coordinate system based on the information of the first position;

obtaining at least one second coordinate of the display content in the display plane coordinate system based on the at least one first coordinate and the homography; and

obtaining the first digital image based on the at least one second coordinate.

In order to illustrate the calculation described above in detail, a detailed process is illustrated below with reference to FIG. 2, and the above steps will not be illustrated separately, however, the detailed calculation process is based on the idea of steps described above. In FIG. 2, the eyes of the user are regarded as a human eye camera, a display plane of the display screen is ABCD, an image is captured at point K by the image acquisition apparatus. Assumed that an imaging plane of the image acquisition apparatus and that of the display screen are the same plane. The information on a first position is acquired by the parameter information, that is, the position of the human eye is point E, A′B′C′D′ is an imaging plane of the human eye. Further, the eye coordinate system is xₑyₑzₑ, the coordinate system of the image acquisition apparatus is x_{c}y_{c}z_{c}. In order to be easy to illustrate a calculation process of the disclosure, the calculation process is illustrated here by taking X(x, y, z) as an example, however, in a case that there are several points in the specific implementation process, a process method for the remaining points is similar.

Assumed that the coordinates of the human eye of the user in the three-dimensional physical coordinate system acquired by analyzing are E(xₑ, yₑ, zₑ), coordinates of a center of display plane ABCD of the display screen in the three-dimensional physical coordinate system are O(xₒ, yₒ, zₒ). Assumed that the human eye is in a process of moving, line of sight of the user faces the center of the display screen, a vector of z-axis in the eye coordinate system xₑyₑzₑ in the three-dimensional physical coordinate system x_{c}y_{c}z_{c} is represented as r_{z}=\vec{EO}=(x₀-xₑ, y₀-yₑ, z₀-zₑ). Assumed that the display plane ABCD of the display screen is perpendicular to the ground, and a direction of yₑ-axis is a direction of the gravity, and a vector of the yₑ-axis in the three-dimensional coordinate system is represented as r_{y}=(0,−1,0). Then, it may be determined from the right hand screw rule that a vector of xₑ in the three-dimensional physical system is represented as rₓ=r_{y}×r_{z}. In order to guarantee three axes of the three-dimensional physical coordinate system are orthogonal with each other, it is required to amend r_{y} as r′_{y}=r_{z}×rₓ.

Subsequently, the normalization operation is performed on the rₓ, r′_{y}, r_{z} respectively, to obtain

$${r}_{1} = \frac{{r}_{x}}{\vert {r}_{x} \vert} , {r}_{2} = \frac{{r}_{y}}{\vert {r}_{y} \vert} , {r}_{3} = \frac{{r}_{z}}{\vert {r}_{z} \vert} .$$

Since r₁, r₂, r₃ in the eye coordinate system may be represented as eₓ=(1,0,0), e_{y}=(0,1,0), e_{z}=(0,0,1), respectively. It may be easy to consider that assumed that the eye coordinate system can be rotated to a plane parallel with the three-dimensional physical coordinate system by one rotation. Then, there are Rₑr1=eₓ, Rₑr2=e_{y}, Rₑr3=e_{z}, a rotation matrix Rₑ=[re1 re2 re3]−1=[rₑ₁ rₑ₂ rₑ₃] for rotating from the three-dimensional physical coordinate system to the eye coordinate system may be obtained.

Further, coordinates of the human eye E in the eye coordinate system are (0, 0, 0), the three-dimensional physical coordinate system is coincide with the eye coordinate system by rotation and one translation, that is, the three-dimensional physical coordinate system is transformed into the eye coordinate system, therefore,

$${R}_{e} + {t}_{e} = {R}_{e} [ \begin{matrix}{x}_{e} \\ {y}_{e} \\ {z}_{e}\end{matrix} ] + {t}_{e} = 0$$

may be obtained, a translation vector

$${t}_{e} = - {R}_{e} E = - {R}_{e} [ \begin{matrix}{x}_{e} \\ {y}_{e} \\ {z}_{e}\end{matrix} ]$$

from the three-dimensional physical coordinate system to the eye coordinate system is therefore calculated. An external parameter [Rₑ tₑ]=[rₑ₁ rₑ₂ rₑ₃ tₑ] of the human eye camera may be obtained based on Rₑ and tₑ.

Further, an internal parameter of the human eye camera is matrix Aₑ, an image of t,24 point X in the imaging plane A′B′C′D′ of the human eyes is point m,

$${λ}_{1} [ \begin{matrix}u \\ v \\ 1\end{matrix} ] = {A}_{e} [ \begin{matrix}{R}_{e} & {t}_{e}\end{matrix} ] [ \begin{matrix}x \\ y \\ z \\ 1\end{matrix} ] \qquad ( equation 1 )$$

is obtained by a calculation, where assumed that coordinates of m in the eye coordinate system are m=(u, v, 1), λ₁ is a vertical distance between point X to the imaging plane of the display screen.

Assumed that a connecting line from point X to the human eye E intersects the imaging plane of the screen at point x, point x is an imaging point of point X in the present position of the human eye, therefore, the user can see that point x in the display screen corresponds to point X in the virtual image. Similarly,

$${λ}_{2} [ \begin{matrix}u \\ v \\ 1\end{matrix} ] = {A}_{e} [ \begin{matrix}{R}_{e} & {t}_{e}\end{matrix} ] [ \begin{matrix}{x}^{′} \\ {y}^{′} \\ {z}^{′} \\ 1\end{matrix} ] \qquad ( equation 1 )$$

may be obtained, λ₂ is a vertical distance between point x and the imaging plane of the human eye. Since the display plane ABCD of the display screen is a plane in which z_{c}=0, the equation described above may be simplified as

$${λ}_{2} [ \begin{matrix}u \\ v \\ 1\end{matrix} ] = {A}_{e} [ \begin{matrix}{R}_{e} & {t}_{e}\end{matrix} ] [ \begin{matrix}{x}^{′} \\ {y}^{′} \\ 0 \\ 1\end{matrix} ] = {A}_{e} [ \begin{matrix}{r}_{e 1} & {r}_{e 2} & {r}_{e 3} & {t}_{e}\end{matrix} ] [ \begin{matrix}{x}^{′} \\ {y}^{′} \\ 0 \\ 1\end{matrix} ] = {A}_{e} [ \begin{matrix}{r}_{e 1} & {r}_{e 2} & {t}_{e}\end{matrix} ] {H}_{e} [ \begin{matrix}{x}^{′} \\ {y}^{′} \\ 1\end{matrix} ] ,$$

where Hₑ is a homography.

Finally,

$$λ [ \begin{matrix}{x}^{′} \\ {y}^{′} \\ 1\end{matrix} ] = {[ \begin{matrix}{r}_{e 1} & {r}_{e 2} & {t}_{e}\end{matrix} ]}^{- 1} [ \begin{matrix}{r}_{e 1} & {r}_{e 2} & {r}_{e 3} & {t}_{e}\end{matrix} ] [ \begin{matrix}x \\ y \\ z \\ 1\end{matrix} ] \qquad ( equation 3 )$$

may be obtained by establishing a simultaneous equations by equation (1) and equation (2), λ=λ₁/λ₂. it may be seen that, by the illustration described above for the predetermined algorithm, after the coordinates of point X in the three-dimensional physical coordinate system are obtained, coordinates of point X in the imaging plane of the display screen can be obtained, the image of point X is then displayed at the calculated position, the user can see from his/her angle of view that the displayed point x corresponds to the virtual image thereof.

Two examples are listed below to calculate.

In an actual implementation process, λ and coordinates of point X in equation 3 described above may be acquired easily by the image acquisition apparatus, assumed that coordinates of X in the three-dimensional physical coordinate system are (1, −2, 3), and λ=2, a homography constructed by the information of the first position acquired based on at least one image is

$${[ \begin{matrix}{r}_{e 1} & {r}_{e 2} & {t}_{e}\end{matrix} ]}^{- 1} = [ \begin{matrix}1 & 0 & 0 \\ 0 & 1 & 0 \\ 0 & 0 & 1\end{matrix} ] , [ \begin{matrix}{r}_{e 1} & {r}_{e 2} & {r}_{e 3} & {t}_{e}\end{matrix} ] [ \begin{matrix}1 & 2 & 4 & 6 \\ 8 & 8 & 6 & 7 \\ 2 & 8 & 5 & 1\end{matrix} ] , \\ [ \begin{matrix}{x}^{′} \\ {y}^{′} \\ 1\end{matrix} ] = [ \begin{matrix}7.5 \\ 8.5 \\ 1\end{matrix} ]$$

is obtained based on the equation 3, that is, x′=7.5, y′=8.5.

Coordinates of X in the three-dimensional physical coordinate system are (10, −8, 6), λ=13, a homography constructed by the information of the first position acquired based on at least one image is

$${[ \begin{matrix}{r}_{e 1} & {r}_{e 2} & {t}_{e}\end{matrix} ]}^{- 1} = [ \begin{matrix}1 & 0 & 0 \\ 0 & 1 & 0 \\ 0 & 0 & 1\end{matrix} ] , [ \begin{matrix}{r}_{e 1} & {r}_{e 2} & {r}_{e 3} & {t}_{e}\end{matrix} ] [ \begin{matrix}1 & 2 & 4 & 6 \\ 8 & 8 & 6 & 7 \\ 2 & 8 & 5 & 1\end{matrix} ] , \\ [ \begin{matrix}{x}^{′} \\ {y}^{′} \\ 1\end{matrix} ] = [ \begin{matrix}1.846 \\ 4.538 \\ 1\end{matrix} ]$$

is obtained based on the equation 3, that is, x′=1.846, y′=4.528.

More examples are not described here any more.

The first digital image is obtained after the coordinates of each point in the plane of the display screen are obtained.

In step S103, once the operator performs a first input operation, a first instruction corresponding to the first input operation is determined based on the first digital image, and an action of the operator for performing the first input operation is presented by the first virtual image.

In the embodiment of the disclosure, the first digital image is used to determine the input operation of the user. That is, the input operation of the user is determined based on the first digital image. Since the first digital image is constructed based on the information on a first position of eyes of the user in the parameter information, the first digital image changes correspondingly when the user moves his/her body or turns the head and therefore the viewpoint changes, then a user's virtual image viewed from a present viewpoint of the user and an input operation of the user can be determined by the first digital image.

For example, when the user views that a virtual image of his/her finger is that a “music” icon is clicked, however, the user's finger does not contact with the display screen, the click action of the user is determined based on the first digital image, and therefore a first instruction generated is an instruction to open a “music” program.

Alternatively, when the user views that a virtual image of his/her arm is that an arm-shaking action is made, the arm-shaking action of the user is determined based on the first digital image, assumed that a relationship between an input action and an instruction of the electronic device indicates that an instruction corresponding to the arm-sharking made by the user is to adjust brightness of the display screen to be the highest brightness, the first instruction generated by the electronic device is an instruction to adjust the brightness of the display screen to be the highest brightness.

Alternatively, the user views his/her face in the mirror, and the first input operation is to turn the user's face from facing the display screen to the right by 45 degrees, the head-turning action of the user and the user turns right by 45 degrees are determined based on the first digital image. Assumed that the relationship between an input action and an instruction of eth electronic device indicates that a video is fast forwarded 3 minutes in a case that the user turns right within 30 degrees, a video is fast forwarded 5 minutes in a case that the user turns right by 30 degrees or more degrees, a video is fast reversed 3 minutes in a case that the user turns left within 30 degrees, a video is fast reversed 5 minutes in a case that the user turns left by 30 degrees or more degrees, an instruction generated the electronic device is an instruction to fast forward the video 5 minutes.

Further, after step S103, the first input operation of the user corresponds to one first instruction, the embodiment of the disclosure further includes:

displaying a first display content on the display screen; and

controlling the display screen to display a second display content different from the first display content in response to the first instruction and based on the first instruction.

Specifically, the first content is displayed on the display screen firstly, the first content may be a file, a picture, a video or the like, which is not limited in the disclosure. When the first instruction is detected by the electronic device, the electronic device controls the display screen to display the second display content different from the first display content in response to the first instruction and based on the first instruction, that is, the first input operation of the user can change a display content of the electronic device.

The first display content and the second display content are illustrated below by an example.

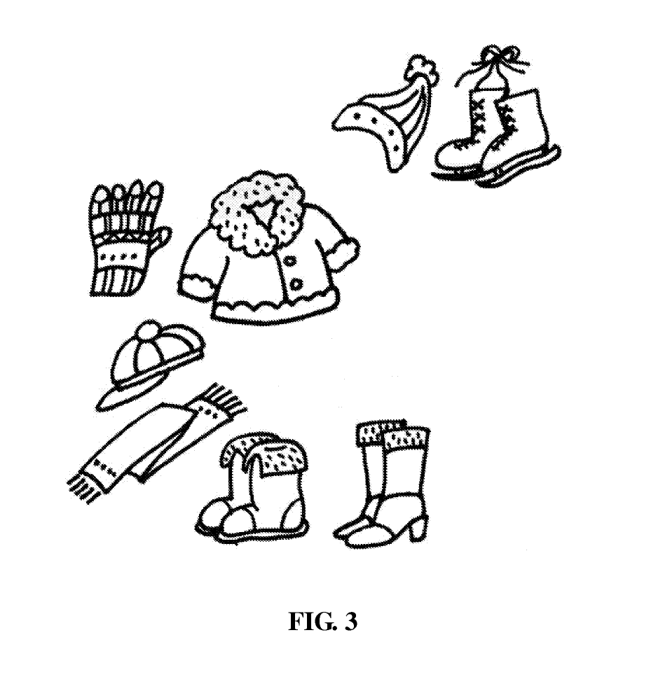

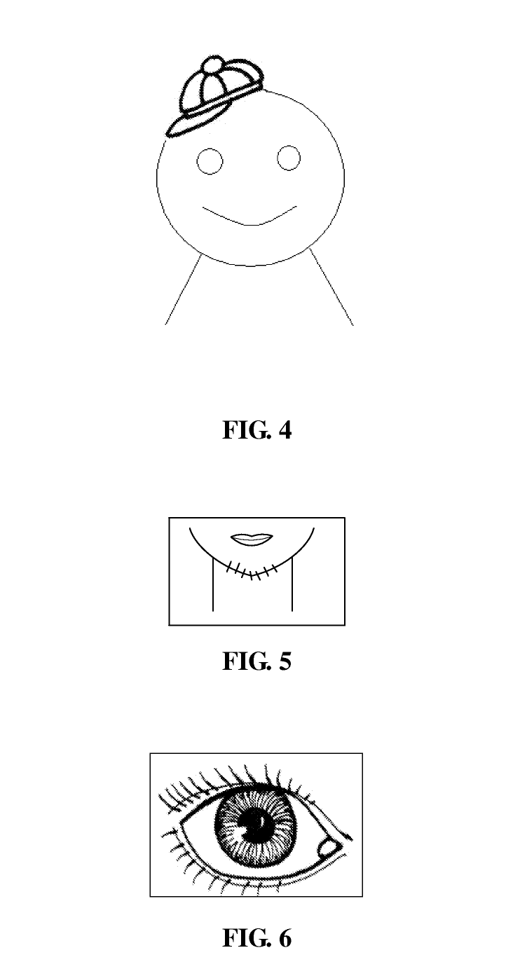

For example, the first display content is as shown in FIG. 3, the display screen of the electronic device displays winter supplies such as a casquette, a scarf and snow boots. The user views his/her first virtual image on the display screen, and can view the first display content simultaneously. The user wants to try whether the winter supplies are suitable for him/her after viewing the winter supplies. Then, the user lifts the arm and views that a virtual image of his/her left hand falls on the casquette, and then the user moves the left hand over his/her head, which sees that that the casquette on the display screen is wore on his/her head. The electronic device determines that the user make an action of wearing the casquette by a first digital image constructed, the display screen then displays a second display content, for example, displays that the casquette is moved from an original display position to a position corresponding to the head in the first virtual image of the user, the user can therefore view that the casquette is on his/her head, as shown in FIG. 4.

Practically, the first display content and the second content may also be others, for example, the first display content is a dialog box, the first input operation of the user is to click the close button of the dialog box without using a mouse, a somatosensory sensor, or contacting the display screen. After the operation of the user is determined based on the first digital image, the second display content is display content after the dialog is closed. Alternatively, for example, the first display content is content on the third page of a novel, the user shakes the right hand without using a mouse or a somatosensory sensor, the second display content on the display screen is a content on the fourth page, the second display content may be selected by those skilled in the art based on an actual needs, which is not limited in the disclosure.

Further, the embodiment of the disclosure further includes:

judging whether the first input operation meets a first preset condition, to obtain a first judging result; and

controlling the display screen to display a first part of the first digital image in a case that the first judging result indicates that the first input operation meets a first preset condition.

Since the user may have different needs when using the display screen in the embodiment of the disclosure, for example, the user may hope to view that the image can be zoomed in or zoomed out or can be rotated by 180 degrees, the user can control the electronic device to display the first digital image by some first input operations meeting the first preset condition, to meet his/her needs.

In the embodiment of the disclosure, the first preset condition for example shaking the right arm by 90 degrees may be preset in the electronic device before the electronic device leaves the factory, or may also be preset by the user. For example, the electronic device prompts the user to enter an operation, and the user may enter an operation based on his/her needs or preferences, such as moving his/her face from a position having 30 cm apart from the display screen to a position having 3 cm apart from the display screen, or making an action of raising head by 15 degrees, the electronic device acquires the input operation of the user by the image acquisition apparatus, and the input operation is encoded as the first preset condition.

When it is required for the user to display the first part of the first digital image, the user enters the input operation meeting the preset condition again.

In order to illustrate more clearly, it is illustrated below by two examples.

User A presets that the first preset condition is that the user raises head by more than 5 degrees. When user A gets up in the morning and shaves, assumed that the first digital image displayed on the display screen at the moment is an image coinciding with the first virtual image which can be viewed by the user A. In order to view his chin clearly, user A moves the head close to the display screen and raises his head slightly simultaneously, assumed that user A raises his head by 8 degrees or 10 degrees, the image acquisition apparatus of the electronic device acquires information, the first input operation meets the first preset condition at the moment. The electronic device analyzes that a region gazed by the eyeball of user A at the moment is his chin, in order to make user A view his chin clearly, the electronic device controls the display screen to display only a first part of the first digital image, that is, a part which the user most wishes to view and view clearly, the part is his chin in the application scenario, as shown in FIG. 5.

User B presets that the first preset condition is that a distance between the head of the user and the display screen is less than 3 cm and a slide action of a finger from up to down is made. When user B gets up in the morning and wears eyeliner in the front of the electronic device, assumed that the first digital image displayed on the display screen at the moment is an image coinciding with the first virtual image which can be viewed by the user. In order to see her eyes, user B moves her head close to the display screen, when a distance between the head of user B to the display screen is less than 3 cm, and user B makes a slide action of a finger from up to down in the front of the display screen, the image acquisition apparatus of the electronic device analyzes that a region gazed by an eyeball of user B at the moment is her eyes based on the acquired information. In this case, the first input operation meets the first preset condition, in order to make user B view her eyes clearly, the electronic device control the display screen to display only a first part of the first digital image, that is, a part which the user most wishes to view and view clearly, the part is her eyes in the application scenario, as shown in FIG. 6.

It may be seen that, in the technical solution of the disclosure, firstly, the parameter information of the operator located in the front of the display screen is captured by using the image acquisition apparatus, the parameter information is used to construct a first digital image corresponding to the operator, and a calculation is made on the parameter information using the predetermined algorithm to obtain the first digital image, the first digital image is used to determine the input operation of the operator, and the first digital image matches with the first virtual image. Then, when a first input operation is performed by the operator, the first instruction corresponding to the first input operation is determined based on the first digital image, and the action of the operator for performing the first input operation is presented by the first virtual image, in this way, the technical problem how the electronic device acquires and determines the input operation of the user is solved, and the technical effect that the first input operation of the user is determined by constructing the first digital image after the parameter information is obtained by the image acquisition apparatus is realized.

Further, although some remote human-computer interaction methods are disclosed in the related art, for example, an action of a hand or a finger of the user is obtained by the image acquisition apparatus, the method in the related art only serves the hand or the finger of the user as a input cursor, can not recognize the body of the user, and can not serve a change in any part of the body of the user sensed as an input operation (for example an input operation of the head, the hand or the like).

Further, in the related art, in order to recognize the input operation of the user, it is required for the user to hold a sensor (for example a gamepad), or wear a sensor device. However, in the technical solution of the disclosure, it is necessary to wear any6 sensor for the user, an action of a whole body of the user can be recognized, the first virtual image presented by the user within the mirror effect is served as a corresponding prompt for the input operation of the electronic device provided by the embodiment of the disclosure, and is identical to the actual action of the user. The first digital image is constructed by the parameter information acquired by the image acquisition apparatus based on the predetermined algorithm, the electronic device provided by the embodiment of the disclosure can obtain the input operation of any part of the body of the user, and performs a corresponding response.

### Second Embodiment

According to the embodiments of the present disclosure, it is provided another method for processing information. In the method, the display screen presents a virtual image space of an environmental space in front of the display screen, with the virtual image space and the environmental space being symmetrical with respect to the display screen, where the virtual image space includes M virtual objects having one-to-one correspondence with M real objects in the environmental space, and M is an integer greater than or equal to 1;

N display objects are constructed, where N is an integer greater than or equal to 1; and

the N display objects are displayed on the display screen and the N display objects are integrated into the virtual image space, such that an observer of the electronic device determines that the environmental space includes M+N real objects based on a display effect of the display screen.

The technical solutions of the disclosure will be illustrated in detail by the accompanying drawings and the specific embodiments hereinafter. It should be understood that the embodiments and the specific features of the embodiments are only illustrative, and do not limit the technical solutions of the disclosure. In the case of no conflict, the embodiments and the technical features of the embodiments may be combined each other.

Before describing the method for processing information according to the embodiment of the disclosure, a basic structure of an electronic device to which the method according to the embodiment of the disclosure is applied is described. Referring to FIG. 8, the electronic device of the embodiment of the disclosure includes display unit 801, which includes a display screen with mirror effect, that is to say, no matter whether the display screen is power-up, the display screen may display a virtual image of an environmental space in front of the display screen based on the physical property thereof, and the virtual image is a virtual space. It may be known based on the optical physical principle that, a size, a position of the virtual space and each object in the virtual space are symmetrical to the environmental space in front of the display screen. In addition, the electronic device in the embodiment of the disclosure also includes processor 802.

The processor 802 is connected to the display unit 1 and configured to construct N display objects, where N is an integer greater than or equal to 1. The processor 802 is also configured to display the N display objects on the display screen and integrate the N display objects into the virtual image space, such that an observer of the electronic device determines that the environmental space includes M+N real objects based on a display effect of the display screen.

Referring to FIG. 9, hereinafter the method for processing information of the discourse is introduced in detail. The method includes step S901 to step S903.

In step S901, the display screen displays a virtual image space of an environmental space in front of the display screen, with the virtual image space and the environmental space being symmetrical with respect to the display screen.

In step S902, N display objects are constructed.

In step S903, the N display objects are displayed on the display screen, and the N display objects are integrated into the virtual image space.

Hereinafter each step and the specific implementing way for each step are illustrated in detail.

Firstly, in step S901, since the display screen in the embodiment of the disclosure has a mirror effect, the display screen may perform step S901 based on its physical property without the processor 802. In the case that the observer stands in front of the display screen, the observer may view his/her virtual image and the virtual image space of the environmental space.

Furthermore, in order to make the visual experience for viewing the mirror effect better for the user, in the embodiment of the disclosure, the processor 802 may also transmit at least one control instruction to the display unit 801, to adjust a display parameter of the display screen, for example a brightness or a color. For example, the current brightness of the display screen may be lowered, for example, the display screen is adjusted from the current brightness value 187 to a brightness value 0, or a display color is adjusted into a color with a low reflection rate such as black, gray, black gray. For example, the display screen currently displays an interface of a web page, different positions in the interface are displayed by different colors, for example, a web site is displayed as black, a slider is displayed as gray and the background of the web page is displayed as sunset yellow, and the display screen adjusts the display color of the whole display screen into a color with a RGB value (0, 0, 0) based on the at least one control information.

That is to say, step S901 may be implemented in combination with the processor 802. Practically, in the specific implementing process, those skilled in the art may select whether to need a display parameter for controlling the display screen and a specific display parameter for controlling based on the actual need, and the disclosure is not limited thereto.

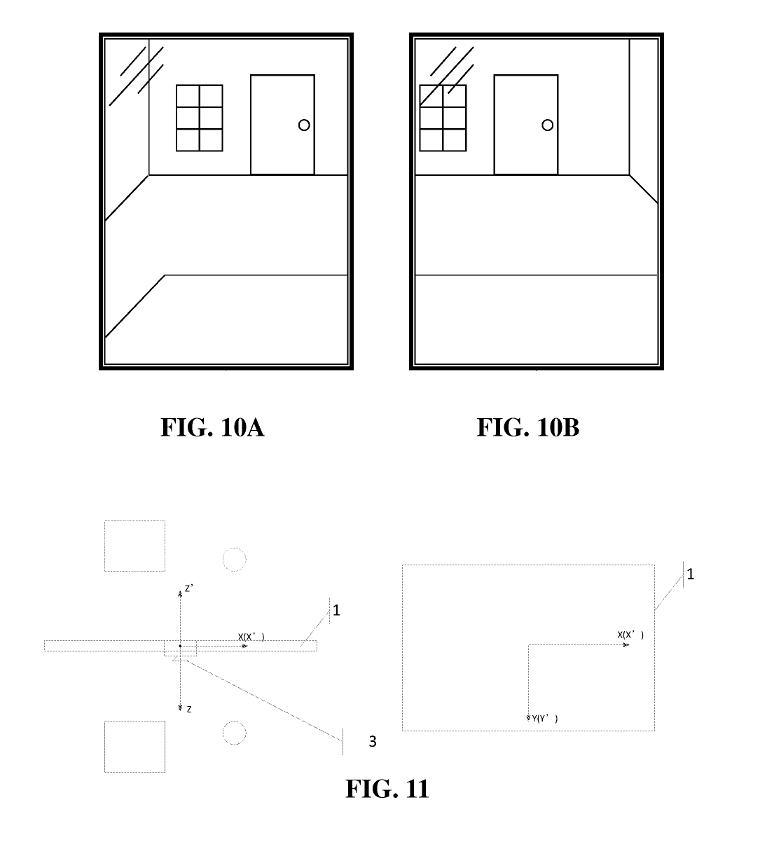

Furthermore, the environmental space includes M real objects and M is an integer greater than or equal to 1. Since M real objects are in the environmental space in front of the display screen, an observer may view M virtual images having one-to-one correspondence with the M real objects in the virtual image space formed by the display screen. For example, if the environmental space includes a door, a window and a desk, the observer may view a virtual image of the door, a virtual image of the window and a virtual image of the desk in the corresponding virtual image space, as shown in FIG. 10A or FIG. 10B.

It should be noted that, those skilled in the art should understand that in the accompanying drawings of the embodiment of the disclosure, different lines are used to only illustrate different sources of the image; and in the specific implementing process, the virtual image and the display mode for the electronic device may not be displayed by a dotted line.

Subsequently, step S902 is performed.

In step S902, N display objects are constructed.

Firstly, N is an integer greater than or equal to 1, for example 1, 3, 5, and the value of N is not limited in the disclosure. In the embodiment of the disclosure, in order to make the electronic device construct the N display objects, before the N display objects are constructed, the method further includes:

at least one parameter of the environmental space is obtained via the image acquisition apparatus; and

a predetermined algorithm for the at least one parameter is performed to obtain a digital space, where the digital space is consistent with the virtual image space.

Specifically, in the embodiment of the disclosure, firstly at least one parameter of the environmental space is obtained via the image acquisition apparatus 803. In the specific implementing process, the image acquisition apparatus 803 may be a three dimensional (3D) camera, a depth camera, or two ordinary cameras, and it is not limited in the disclosure. The image acquisition apparatus 803 obtains at least one parameter of the environmental space by photographing at least two frames of images or a dynamic image. The at least one parameter includes but not limits to depth information of each point in the environmental space, coordinate values of each point of the environmental space under the 3D coordinate system of the image acquisition apparatus 803, a size of the environmental space, a distance from the M real objects to the image acquisition apparatus 803 in the environmental space, a size of the M real objects and a distance and an angle between the M real objects etc. For example, if the environmental space is a study of an observer, the at least one parameter obtained via the image acquisition apparatus may include: a space of 2.7 m×3 m×2.9 m, a door located at a position with 2.64 m from the image acquisition apparatus in the space, a window located close to the door, with a distance 4.5 m from the door to the window, and a desk located at a position with 0-0.3 m from the image acquisition apparatus in a horizontal direction.

Although the observer may view the virtual image space based on the mirror effect and the status of the environmental space may be known based on the virtual image space, for example the size of the environmental space, the M real objects in the environmental space, the electronic device does not detect the environment space, hence a digital space needs to be constructed based on the at least one parameter obtained via the image acquisition apparatus 803, such that the electronic device knows the status of the environmental space and the virtual image space. In the embodiment of the disclosure, the digital space is consistent with the virtual image space.

Specifically, in the implementing process, the digital space may be constructed by many modes. Hereinafter it is introduced by taking the image acquisition apparatus 803 being a depth camera as an example.

In the case that the image acquisition apparatus 803 is a depth camera, at least one parameter of the environmental space, i.e. depth information of each point in the environmental space, may be obtained via the depth camera, the depth information includes a distance from each point to the depth camera, and the distance of each point in a horizontal direction and a vertical direction.

It is assumed that the depth camera is arranged top of the display screen and an imaging plane of the depth camera and the display plane of the display screen are coplanar. Since the imaging plane of the depth camera and the display plane are coplanar, for the same point in the environmental space, a distance from the depth camera is the same as a distance from the display screen, thereby for the coordinate values of the same point under the three dimensional system of the depth camera and under the coordinate system of the virtual image space, two coordinate values are equal while another coordinate value is opposite. As shown in FIG. 11, a square and a circle indicated by a solid line represent 2 real objects in the environmental space, while a square and a circle indicated by a dotted line composed of short lines and points represent 2 virtual objects in the virtual image space corresponding to the 2 real objects, with the 2 virtual objects and the 2 real objects are symmetrical with respect to the display screen. It is assumed that an origin of the two coordinate system described above each is located at a centre of the display screen, the positive direction of Y axis and Y′ axis of the two coordinate systems each are upward perpendicular to the ground, the positive direction of X axis and X′ axis of the two coordinate systems are towards right parallel to the ground, the positive direction of Z axis of the coordinate system of the depth camera is perpendicular to the display plane and towards the environmental space, while the positive direction of Z′ axis of the coordinate system of the virtual image space is perpendicular to the display plane and towards the reverse direction of the environmental space. For example, if coordinate values of point S under the three dimensional coordinate system of the depth camera are (12, 5, 2), coordinate values of the point S under the coordinate system of the virtual image space are (12, 5, −2).

In the case that the depth camera obtains a depth of each point in the environment space and a distance from each point to the depth camera in both the horizontal direction and the vertical direction, the coordinate values of each point in the environmental space under the three dimensional coordinate system of the depth system may be obtained, then the Z coordinate of coordinates of each point is replaced with its opposite number, the electronic device may obtain a digital space, i.e. the status of the virtual image space presented on the display screen by the user, which is in consistent with the virtual image space correspondingly. The electronic device may know the virtual image space based on the digital space.

In the specific implementing process, in the case that the image acquisition apparatus 803 may be not a depth camera, for example may be a 3D camera or two ordinary cameras, the principle for obtaining the digital space is still that the depth value of each point is replaced with its opposite number to obtain coordinate values of each point under the three dimensional coordinate system of the virtual image space. Those skilled in the art may obtain the digital space based on the disclosed ways above, which is not described here.

After the digital space is constructed, the electronic device knows the status of the environmental space and the virtual image space which is viewed by the observer in the display screen, and N display objects may be constructed to cooperate with the virtual image space.

The electronic device may randomly construct the N display objects, for example the electronic device randomly constructs a smiling face or two hearts. Alternatively, the electronic device may construct the N display objects based on a certain data. Since data in the electronic device have many kinds and sources, the N display objects are constructed by many ways. Hereinafter 3 ways for constructing the N display objects are introduced, the specific implementing process includes but not limits to the following 3 ways.

In a first way, the N display objects are constructed based on a standard data in a database.

Specifically, in the embodiment of the disclosure, the database may be a local database of the electronic device, or a remote database connected to the electronic device via the internet, and it is not limited in the disclosure. Since in the related art data of the most objects are known, for example a diameter of a cup, a height of a cup body, a radian and a length of a handle, a color and a pattern of a cup, and even a three dimensional image of a cup, the electronic device may construct the N display objects based on data existing in the database.

For example, the electronic device provides a menu for a user, the user selects “a wall clock” in the menu, then the electronic device obtains data information of the wall clock from the local database; while in the case that the local database does not have data information of the wall clock, the electronic device may construct a wall clock based on data information, for example a size of the wall clock, an image of the wall clock, downloaded from the internet server.

In a second way, the N display objects are constructed based on data obtained from another electronic device connected to the electronic device.

The electronic device may connect to another electronic device via the internet, WLAN, a Bluetooth etc. In the case that the N display objects to be constructed by the electronic device are related to another electronic device, the electronic device may transmit a data request to another connected electronic device; and after receiving the data request, another electronic device transmits data for constructing the N display objects to the electronic device.

For example, user A is performing a video chat with user B via the electronic device in the embodiment of the disclosure, and the electronic device is connected with the electronic device used by user B. It is assumed that the display object to be constructed by the electronic device is user B, the electronic device in the embodiment of the disclosure transmits a data request to the electronic device used by user B, the electronic device used user B obtains data information such as an appearance, a contour of user B via a camera used by the user B in the video chatting, and then transmits the data information of user B to the electronic device. After receiving the data of user B, the electronic device may construct a display object of a virtual user B based on the data of user B and the constructed user B is a user who is speaking, that is to say, a moving display object may be constructed.

In a third way, the N display objects are constructed based on historical data in the electronic device.

Specifically, in the embodiment of the disclosure, the electronic device may construct the N display objects based on historical data in the electronic device, for example historical image data or historical video data.

For example, the user of the electronic device photographs a video lasting for 10 seconds with a camera 10 days ago, in which the user speaks towards the camera; in the case that the electronic device constructs a display object, the electronic device may construct a display object corresponding to the virtual image of the user based on each frame of image data in the video 10 days ago, and the display object constructed is the user who is speaking, that is to say, a moving display object may be constructed.

Subsequently, step S903 is performed.

In step S903, the N display objects are displayed on the display screen, and the N display objects are integrated into the virtual image space.

Specifically, in the embodiment of the disclosure, N display objects are integrated into the virtual image space in displaying the N display objects, such that an observer of the electronic device views that the environmental space in front of the display screen includes M+N real objects based on a display effect of the display screen.

In the embodiment of the disclosure, in order to integrate the N display objects into the virtual image space in displaying the N display objects on the display screen, the implementing process for step S903 may include:

the N display objects and N positions of the N display objects in the digital space are determined based on the digital space;

N display positions on the display screen corresponding to the N positions in the digital space are determined; and

the N display objects are displayed at the N display positions on the display screen.

Firstly, the N display objects and N positions of the N display objects in the digital space are determined based on the digital space.

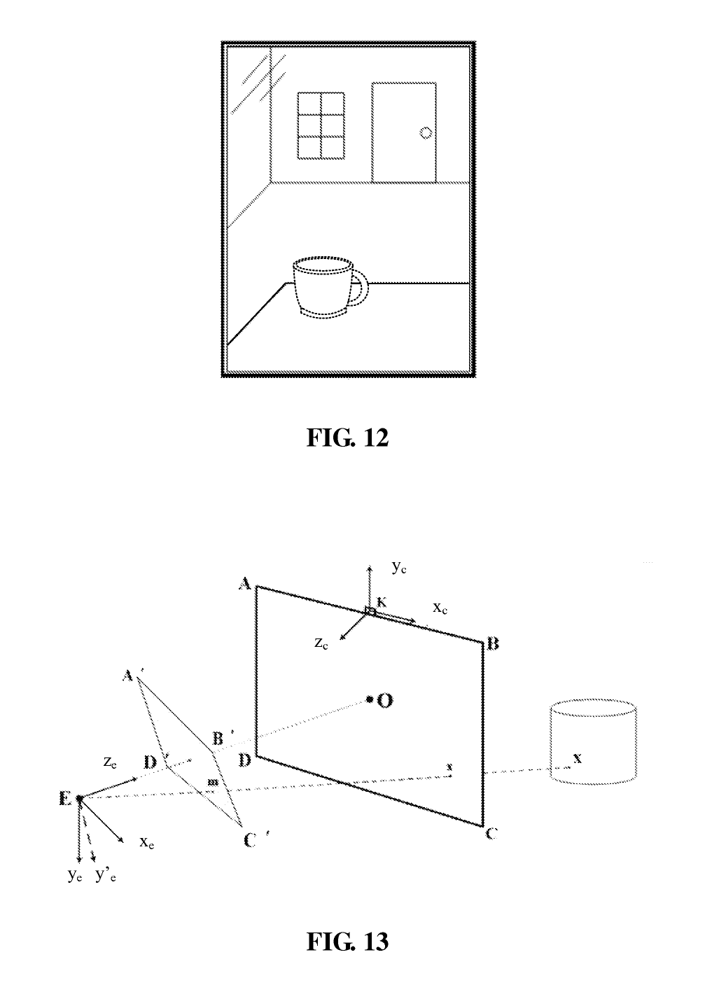

Specifically, in the embodiments of the disclosure, in order to generate an effect that the observer views that the N display objects are integrated into the virtual image space in displaying the N display objects on the display screen, the electronic device disposes the N display objects in the obtained digital space. For example in FIG. 10A, the virtual image space is a study including a desk, and the electronic device in the embodiment of the disclosure is disposed on the desk. The digital space of the electronic device is also a study including a desk, and the desk in the digital space is a part which may be acquired by the image acquisition apparatus, the digital space is in consistent with the virtual image space. Since the digital space is a study, N display objects to be constructed by the electronic device are office supplies, for example a cup; since the cup is generally disposed close to the electronic device on the desk, the electronic device disposes the cup on the desk in the digital space, as shown in FIG. 12. Therefore, a position of the display object, i.e. the cup, in the digital space is determined as the position on the desk shown in FIG. 12.

Subsequently, it is to determine N display positions on the display screen corresponding to the N positions in the digital space in displaying the N display objects, i.e., a first display position on the display screen for displaying a first display object, a second display position on the display screen for displaying a second display object, a third display position on the display screen for displaying a third display object, . . . , a N-th display position on the display screen for displaying a N-th display object.

In the case that the observer views the virtual image space in different positions, the virtual image space varies as different visual angles of the observer. As shown in FIGS. 10a and 10b, in the case that the observer views the virtual image space in the display screen at position 1, the observer may view a corner of a wall close to the window; and in the case that the observer views the virtual image space in the display screen at position 2, the observer can not view the corner of the wall close to the window, but can view a corner of a wall close to the door.

Similarly, in the case that the observer views the virtual image space in different positions, the observed M virtual objects vary as different visual angles of the observer. As shown in FIG. 10A, in the case that the observer views the virtual image space in the display screen at the position 1, the observer can view a corner of the desk. As shown in FIG. 10B, in the case that the observer views the virtual image space in the display screen at the position 2, the observer can not view the corner of the desk, but only can view an edge of the desk.

Therefore, in order to determine N display positions of the N display objects on the display screen corresponding to the N positions in the digital space, the electronic device needs to obtain the visual angle of the observer.

Specifically, in the embodiment of the disclosure, the visual angle of the observer may be obtained by utilizing at least one parameter, i.e. an acquired image, obtained via the image acquisition apparatus. A position of a head of the observer is obtained from the image by a the method of skeleton data extracting of Kinect SDK, thereby the visual angle of the observer is obtained by taking the position of the head as a position of an eye. The position of the eye may be extracted accurately by three-dimensional face modeling, the specific implementing process is similar to that in the related art, which is not described here.

Furthermore, after the visual angle of the observer, i.e. the position of the eye, is obtained, the N display positions of the N display object on the display screen may be obtained. Hereinafter the calculating process is explained in detail.

Referring to FIG. 13, two eyes of the observer are regarded as an eye camera, a display plane of the display screen is plane ABCD, the image acquisition apparatus acquires an image at point K, and it is assumed that an imaging plane of the image acquisition apparatus and a display plane of the display screen are coplanar. The visual angle of the observer, i.e. the position of the eye, obtained based on at least one parameter is located at point E, and plane A′B′C′D′ is an imaging plane of the eye. Furthermore, a coordinate system of the eye is coordinate system xₑyₑzₑ, while a three dimensional physical coordinate system of the image acquisition apparatus is coordinate system x_{c}y_{c}z_{c}. For facilitating to illustrate the calculating process in the disclosure, it is illustrated only by taking point X (x, y, z) as an example, but there are several points in the implementing process, and the method for processing other points is similar.

Assuming it is obtained by analyzing that coordinates of an eye of the user under the three dimensional physical coordinate system are E (xₑ, yₑ, zₑ), and coordinates of a center of the display plane ABCD of the display screen under the three dimensional physical coordinate system are O (xₒ, yₒ, zₒ). If the line of sight of the observer towards the centre of the display screen, a vector of the z axis of the eye coordinate system xₑyₑzₑ is represented as r_{z}=\vec{EO}=(x₀-xₑ, y₀-yₑ, z₀-zₑ) under the three dimensional physical coordinate system x_{c}y_{c}z_{c}. It is assumed that the display plane ABCD of the display screen is perpendicular to the ground, the positive direction of the yₑ axis is the direction of the gravity, and a vector of the yₑ axis is represented as r_{y}=(0, −1, 0) under the three dimensional physical coordinate system, thereby it may be determined based on the right hand screw rule that a vector of xₑ is represented as rₓ=r_{y}×r_{z} under the three dimensional physical coordinate system. In order to make sure that the three coordinate axes are orthogonal under the three dimensional coordinate system, hence the r_{y} is revised as r′_{y}=r_{z}×rₓ.

Subsequently, the rₓ, r′_{y}, r_{z} are normalized respectively, i.e.,

$${r}_{1} = \frac{{r}_{x}}{\vert {r}_{x} \vert} , {r}_{2} = \frac{{r}_{y}}{\vert {r}_{y} \vert} , {r}_{3} = \frac{{r}_{z}}{\vert {r}_{z} \vert} .$$

Since r₁, r₂, r₃ may be represented as eₓ=(1, 0, 0), e_{y}=(0, 1, 0), e_{z}=(0, 0, 1) under the eye coordinate system respectively, it may be easily conceived that it may be rotated from the eye coordinate system to a space parallel with the three dimensional physical coordinate system. Hence Rₑr₁=eₓ, Rₑr₂=e_{y}, Rₑr₃=e_{z}, thereby it may be obtained that a rotation matrix from the three dimensional physical coordinate system to the eye coordinate system is Rₑ=[re₁ re₂ re₃]⁻¹=[rₑ₁ rₑ₂ rₑ₃].

Furthermore, coordinates of the eye E are (0, 0, 0) under the eye coordinate system, the three dimensional physical coordinate system may be coincident with the eye coordinate by rotating and translating, i.e., transforming from the three dimensional physical coordinate system to the eye coordinate system. Hence it may be obtained

$${R}_{e} + {t}_{e} = {R}_{e} [ \begin{matrix}{x}_{e} \\ {y}_{e} \\ {z}_{e}\end{matrix} ] + {t}_{e} = 0 ,$$

thereby it is obtained by calculating that a translating vector from the three dimensional physical coordinate system to the eye coordinate system is

$${t}_{e} = - {R}_{e} E = - {R}_{e} [ \begin{matrix}{x}_{e} \\ {y}_{e} \\ {z}_{e}\end{matrix} ] .$$

Thereby it may be obtained based on Rₑ and tₑ that an external parameter of the eye camera is [Rₑ tₑ]=[rₑ₁ rₑ₂ rₑ₃ tₑ].

Furthermore, an internal parameter matrix of the eye camera is Aₑ, an image of the point X in the eye imaging plane A′B′C′D′ is point m, it may be obtained by calculating that

$${λ}_{1} [ \begin{matrix}u \\ v \\ 1\end{matrix} ] = {A}_{e} [ {R}_{e} {t}_{e} ] [ \begin{matrix}x \\ y \\ z \\ 1\end{matrix} ] , \qquad ( equation 1 )$$

where coordinates of the point m under the eye coordinate system is m=(u, v, 1), and λ₁ is a vertical distance from the point X to the imaging plane of the display screen.

It is assumed that the display plane of the display screen and a connecting line between the point X and the eye E intersect at point x, the point x is equivalent to an image of the point X with the eye locating at the current position, thereby the user may determine the point x corresponds to the virtual image of the point X. Similarly, it may obtained

$${λ}_{2} [ \begin{matrix}u \\ v \\ 1\end{matrix} ] = {A}_{e} [ {R}_{e} {t}_{e} ] [ \begin{matrix}{x}^{′} \\ {y}^{′} \\ {z}^{′} \\ 1\end{matrix} ] , \qquad ( equation 2 )$$

where λ₂ is a vertical distance from the point x to the eye imaging plane A′B′C′D′. Since the display plane ABCD of the display screen is a plane with z_{c}=0, the equations described above may be simplified as

$${λ}_{2} [ \begin{matrix}u \\ v \\ 1\end{matrix} ] = {A}_{e} [ {R}_{e} {t}_{e} ] [ \begin{matrix}{x}^{′} \\ {y}^{′} \\ {z}^{′} \\ 1\end{matrix} ] = {A}_{e} [ {r}_{e 1} {r}_{e 2} {r}_{e 3} {t}_{e} ] [ \begin{matrix}{x}^{′} \\ {y}^{′} \\ 0 \\ 1\end{matrix} ] = {A}_{e} [ {r}_{e 1} {r}_{e 2} {t}_{e} ] {H}_{e} [ \begin{matrix}{x}^{′} \\ {y}^{′} \\ 1\end{matrix} ] ,$$

where Hₑ is an identity matrix.

Finally, it may be obtained by combining the equation (1) and the equation (2) that

$$λ [ \begin{matrix}{x}^{′} \\ {y}^{′} \\ 1\end{matrix} ] = {[ {r}_{e 1} {r}_{e 2} {t}_{e} ]}^{- 1} [ {r}_{e 1} {r}_{e 2} {r}_{e 3} {t}_{e} ] [ \begin{matrix}x \\ y \\ z \\ 1\end{matrix} ] , \qquad ( equation 3 )$$

where λ=₁/λ₂. It may be seen that, based on the illustration of the predetermined algorithm, after specific coordinate values of the point X under the three dimensional physical coordinate system are obtained, coordinates of the point X on the display plane of the display screen may be obtained, the point X is displayed at the calculated position, and the user may see the displayed point x with his/her visual angle.

It is calculated by the following two specific examples.

In the specific implementing process, λ and coordinates of the point X in the above equation 3 may be easily obtained via the image acquisition apparatus. It is assumed that coordinates of the point X under the three dimensional physical system are (1, −2, 3) and λ=2, the identity matrix constructed based on first position information obtained from at least one image is

$${[ {r}_{e 1} {r}_{e 2} {t}_{e} ]}^{- 1} = [ \begin{matrix}1 & 0 & 0 \\ 0 & 1 & 0 \\ 0 & 0 & 1\end{matrix} ] , \\ [ {r}_{e 1} {r}_{e 2} {r}_{e 3} {t}_{e} ] = [ \begin{matrix}1 & 2 & 4 & 6 \\ 8 & 8 & 6 & 7 \\ 2 & 8 & 5 & 1\end{matrix} ] ,$$

then it may be calculated based on the equation 3

$$[ \begin{matrix}{x}^{′} \\ {y}^{′} \\ 1\end{matrix} ] = [ \begin{matrix}7.5 \\ 8.5 \\ 1\end{matrix} ] ,$$

i.e., x′=7.5, y′=8.5.

Coordinates of X under the three dimensional physical coordinate system are (10, −8, 6), λ=13, the identity matrix constructed based on the first position information obtained from the at least one image is

$${[ {r}_{e 1} {r}_{e 2} {t}_{e} ]}^{- 1} = [ \begin{matrix}1 & 0 & 0 \\ 0 & 1 & 0 \\ 0 & 0 & 1\end{matrix} ] , \\ [ {r}_{e 1} {r}_{e 2} {r}_{e 3} {t}_{e} ] = [ \begin{matrix}1 & 2 & 4 & 6 \\ 8 & 8 & 6 & 7 \\ 2 & 8 & 5 & 1\end{matrix} ] ,$$

then it may be obtained based on the equation 3

$$[ \begin{matrix}{x}^{′} \\ {y}^{′} \\ 1\end{matrix} ] = [ \begin{matrix}1.846 \\ 4.538 \\ 1\end{matrix} ] ,$$

i.e., x′=1.846, y′=4.528.

More examples are not described here.

It may be obtained by calculating a position of each display object on the display screen, in displaying the N display objects in the digital space on the display screen, thereby N display positions of the N display objects are determined. Some points are sheltered after calculation, the sheltered points are not displayed, while other points may turn from the sheltered state to the unsheltered state, these points are displayed, thereby N display modes are determined.

Subsequently, the electronic device displays the N display objects at the N display positions in the N display modes. Specifically, in the case that in step S901 the electronic device adjusts the display color of the display screen to a color with a low reflection rate such as black, gray, black gray, the colors of the N display positions are displayed as the colors of the N display objects in displaying the N display objects.

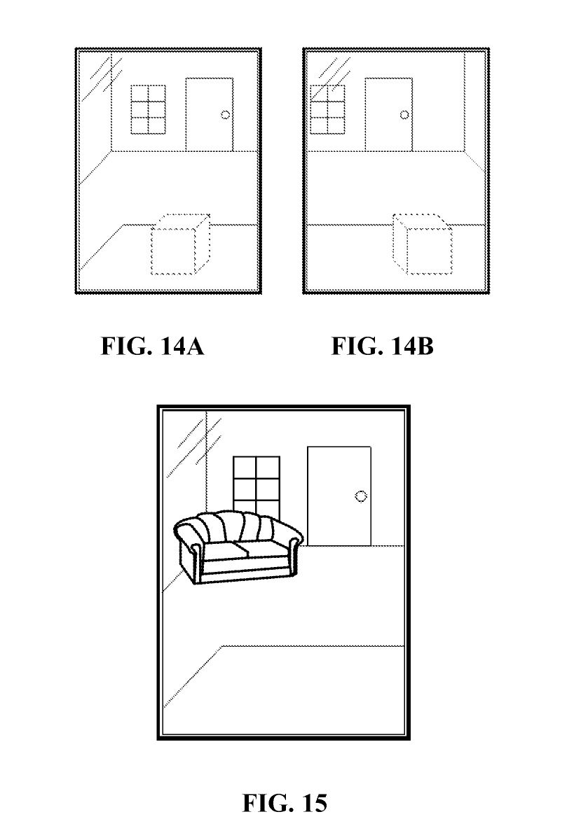

As shown in FIG. 14A, for example the display object is a cube, and the effect of the whole display screen is shown as FIG. 14A. The solid line represents a virtual image space which may be viewed by the user based on the mirror effect, the dotted line represents a cube displayed by the display screen under the control from a processor, and the observer may view a cube disposing on a desk and the front surface, the top surface and the right surface of the cube.

For example, as shown in FIG. 15, the display object is a sofa, the effect of the whole display screen is shown as FIG. 15. The solid line represents a virtual image space which may be viewed by the user based on the mirror effect, the dotted line represents a sofa displayed by the display screen under the control from the processor, and the observer may view that a sofa is disposed in the study.

Based on the example mentioned above, it is assumed that user A and user B are performing a video chat, the electronic device in the embodiment of the disclosure connects to the electronic device used by user B, in the case that the display object to be constructed is user B, data of user B such as an appearance, a contour of user B is obtained from the electronic device used by user B, and user B is displayed on the display screen, and user A views that user B stands close to user A and chats with him/her.

In addition, it is assumed that the electronic device constructs the N display objects based on historical data as the above example, the user of the electronic device photographs a video lasting for 10 seconds 10 days ago, in which the user speaks to a camera, the electronic device may construct a display object corresponding to the virtual image of the user based on each frame of image data in the video 10 days ago, the display object constructed is the user who is speaking, and the constructed display object, i.e. the user himself 10 days ago, is displayed on they display screen, thereby the user views that the user 10 days ago speaks to himself.

Furthermore, since the virtual image space includes M real objects, the observer may be one of the M real objects; and the observer may walk, for example walking towards the electronic device or waking away from the electronic device, thereby at least one of the M real objects is a real moving object. In the case that at least one of the M real objects is a real moving object, the image acquisition apparatus may acquire the movement of the at least one real moving object, and the electronic device in the embodiment of the disclosure may adjust the displaying based on the movement. Therefore, the electronic device in the embodiment of the disclosure regards the at least one real moving object as at least one operator. The method for processing information in the embodiment of the disclosure may further include the following steps:

a moving parameter of the at least one real moving object is obtained via the image acquisition apparatus;

at least one operating position for the at least one operator in the digital space is determined based on the digital space and the moving parameter; and

an input operation performed by the operator for the N display objects is determined based on the at least one operating position.

Firstly, a moving parameter of the at least one real moving object is obtained via the image acquisition apparatus. Specifically, in the embodiment of the disclosure, the moving parameter includes but not limits to a moving direction, a moving speed, a moving track, a starting point and an end point of the at least one real moving object.

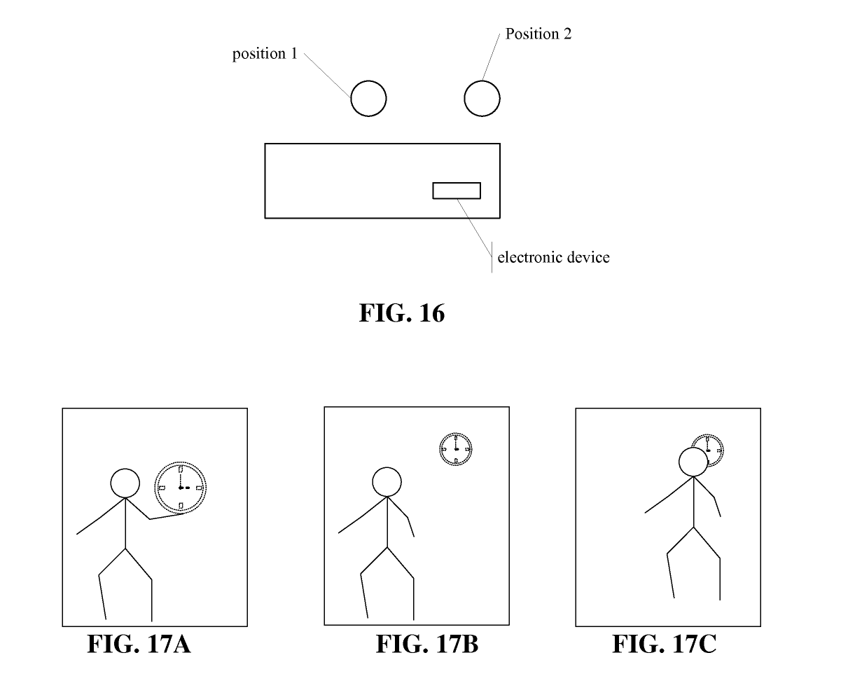

It is assumed that the at least one real moving object is the observer, the observer walks from the position 1 to the position 2 in FIG. 16, thereby the obtained moving parameter is an end point of the moving of the observer or coordinates of the position 2 in the digital space. Alternatively, it is assumed that the at least one real moving object is a palm of the observer, the observer lifts the palm from a height as high as the shoulder to a height as high as the head, thereby the obtained moving parameter are coordinates of a position as high as the head where the palm reaches finally.

Subsequently, at least one operating position for the at least one operator in the digital space is determined based on the digital space and the moving parameter.

Specifically, in the embodiment of the disclosure, since the at least one real moving object moves in the environment space, the observer may view the moving status of the at least one real moving object in the virtual image space displayed on the display screen, while in the digital space the electronic device regards the at least one real moving object as at least one operator. Therefore, the electronic device may determine the moving track of the at least one operator in the digital space based on the moving parameter, thereby determining an end position of the at least one operator, i.e., at least one operating position.

Subsequently, the electronic device determines an input operation performed by the operator for the N display objects, based on the at least one operating position.

Specifically, in the embodiment of the disclosure, the electronic device determines a digital operation to be performed to the N display objects by the observer based on at least one operating position, after determining the at least one operating position for the at least one operator in the digital space.

Subsequently, the method for processing information in the embodiment of the disclosure also includes that:

the N display objects are disposed at N new positions in the digital space based on the input operation.

Specifically, since the electronic device determines the input operation performed by the at least one operator for the N display objects in the digital space, the electronic device disposes the N display objects at N new positions in the digital space.

Furthermore, in order to enable the observer to view that the N display objects are disposed at the N new positions, in the embodiment of the disclosure, the electronic device may also control the display screen to display the N display objects at the N new display positions in N new display modes, where the process for obtaining the N new display modes and the N new display positions is similar to the process for obtaining the N display modes and the N display positions, which is not described.

In order to clearly illustrate the implementing process of the solutions described above, it is illustrated by several specific examples hereinafter.

(1) As shown in FIG. 17A to FIG. 17B, it is assumed that the display object is a wall clock, and the at least one real moving object is a hand of the observer. Firstly the electronic device displays a wall clock on the display screen and the wall clock is displayed on the hand of the observer. In this case, it may be viewed that the right hand of the observer lists as high as the shoulder in the virtual image space of the display screen while the display screen only displays the wall clock, and the observer views that the observer's right hand lifts the wall clock. Subsequently, a moving parameter of the observer's hand is obtained via the image acquisition apparatus, and the electronic device obtains by analyzing the moving parameter that the observer lifts the hand up and slaps the wall behind the observer. The electronic device regards the palm of the observer as an operator, and obtains by analyzing the moving parameter that an operation position for the operator corresponding to the observer's hand is on the wall and an input operation performed by the operator to the wall clock is hanging the wall clock on the wall.

Hence, in the digital space, the wall clock is moved from the original position to a position in the digital space corresponding to the position on the wall where the observer slaps. The electronic device calculates a new display position corresponding to the potion in the digital space and displays the wall clock at the new display position. As shown in FIG. 17B, the observer views that the wall clock is hung on the wall after the observer slaps the wall.

(2) It is also assumed that the display object is a wall clock, and at least one real moving object is the observer's head. The observer walks from a position in FIG. 17B to a position in FIG. 17C, the electronic device obtains the movement of the observer and the moving track of the observer's head via the image acquisition apparatus, and obtains by analyzing that an operating position for the head is the position in FIG. 17 where the head is located. In the digital space, the electronic device regards the head of the observer as an operator, and determines that an input operation performed by the operator for the wall clock is sheltering one part of the wall clock, thereby in the digital space only the other part of the wall clock is displayed, as shown in FIG. 17C. In order to enable the observer to view the change, only one part of the wall clock is displayed on a corresponding display position.

Hence, the observer views a virtual image that the observer walks from the position in FIG. 17B to the position in FIG. 17C in the virtual image space of the display screen, while the electronic device adjusts to display one part of the wall clock in the digital space, and finally the observer views that the observer's head shelters one part of the wall clock hung on the wall.

(3) It is assumed that the display object is a cube in FIG. 8, and the at least one real moving object is two eyes of the observer. The observer moves from the position 1 to the position 2 in FIG. 16, the electronic device obtains the movement of the observer and a moving track of the observer's head via the image acquisition apparatus, and obtains by analyzing that the observer's head moves to the position 2, thereby the two eyes of the observer move to the position 2, hence the visual angle of the observer for viewing the cube and the virtual image space changes. In the digital space, the electronic device regards the two eyes of the observer as an operator, since the two eyes of the observer do not contact the cube, it is determined that the input operation performed by the operator to the wall clock is a null operation, and the position of the cube in the digital space does not change. However, since the visual angle of the observer changes, the display mode for displaying the cube on the display screen is changed.

Therefore, the observer views a virtual image that the observer moves from the position 1 to the position 2 in the virtual image space of the display screen, and the cube does not change in the digital space. However, a front surface, a top surface and a left surface of the cube are displayed in displaying the cube on the display screen, the observer views that the observer walks from the position 1 to the position 2, the cube keeps unchanged on the desk and another side surface of the cube is viewed by the observer, as shown in FIG. 14B.

### Third Embodiment

With reference to FIG. 7, according to the embodiment of the disclosure, it is provided an electronic device. the electronic device includes a display screen having a mirror effect, that is, a first virtual image of an operator can be displayed on the display screen by the physical property of the display screen, regardless whether the display screen is powered up, it may be known from an optical principle that the first virtual image is symmetrical to the operator with respect to the surface of the display screen. In addition, the electronic device in the embodiment of the disclosure further has an image acquisition apparatus. With reference to FIG. 7, the electronic device in the embodiment of the disclosure further includes:

a first obtaining unit 1, configured to obtain parameter information of the operator located in the front of the display screen by using the image acquisition apparatus, where the parameter information is used to construct a first digital image corresponding to the operator located in the front of the display screen;

a second obtaining unit 2, configured to perform a calculation using a predetermined algorithm on the parameter information to obtain a first digital image, where the first digital image is used to determine an input operation of the operator, and the first digital image matches with the first virtual image; and

a determining unit 3, configured to determine a first instruction corresponding to a first input operation based on the first digital image when the operator performs the first input operation, and present an action of the operator for performing the first input operation by the first virtual image.

Further, the electronic device further includes:

a display unit, configured to display a first display content on the display screen, and control the display screen to display a second display content different from the first display content in response to a first instruction and based on the first instruction, after the first instruction corresponding to the first input operation is determined based on the first digital image when the operator performs the first input operation, and an action of the operator for performing the first input operation is presented by the first virtual image.

Further, the electronic device further includes:

a first determining unit, configured to determine whether the first input operation meets a first preset condition, to obtain a first determining result, after the first instruction corresponding to the first input operation is determined based on the first digital image when the operator performs the first input operation, and the action of the operator for performing the first input operation is presented by the first virtual image, or the display screen is controlled to display the second display content different from the first display content in response to the first instruction and based on the first instruction; and

a controlling unit, configured to control the display screen to display a first part of the first digital image in the case that the first determining result indicates that the first input operation meets the first preset condition.

In the embodiment of the disclosure, the second acquiring apparatus 2 includes:

a first obtaining module, configured to obtain at least one first coordinate of a display content on the display screen in an eye coordinate system based on the parameter information;

a second obtaining module, configured to obtain information on a first position of eyes of a user based on the parameter information; and

a third obtaining module, configured to perform a first calculation on the information of the first position and the at least one first coordinate, to obtain the first digital image.

Specifically, the third obtaining module is configured to:

construct a homography of the coordinate system of the display screen corresponding to the eye coordinate system based on the information of the first position;

obtain at least one second coordinate of the display content in the display plane coordinate system based on the at least one first coordinate and the homography; and

obtain the first digital image based on the at least one second coordinate.

The second embodiment is based on the same inventive concept as the first embodiment, and the repetition part will not be described here any more.

One or more technical solutions described above in the embodiment of the disclosure at least have the following one or more technical effects.

1. In the technical solution of the disclosure, firstly, the parameter information of the operator located in the front of the display screen is captured by using the image acquisition apparatus, the parameter information is used to construct a first digital image corresponding to the operator, and a calculation is performed on the parameter information and using the predetermined algorithm to obtain the first digital image. The first digital image is used to determine the input operation of the operator, and the first digital image matches with the first virtual image, then, when a first input operation is performed by the operator, the first instruction corresponding to the first input operation is determined based on the first digital image, and the action of the operator for performing the first input operation is presented by the first virtual image. Therefore, the technical problem how the electronic device including the mirror display screen obtains and determines the input operation of the user is solved, and the technical effect that the first input operation of the user is determined by constructing the first digital image after the parameter information is obtained by the image acquisition apparatus is realized.

### Fourth Embodiment

According to the embodiment of the present disclosure, it is provided another electronic device, as shown in FIG. 8, the electronic device includes: a display screen having a mirror effect, that is, a first virtual image of an operator can be displayed on the display screen by the physical property of the display screen, regardless whether the display screen is powered up, it may be known from an optical principle that the first virtual image is symmetrical to the operator with respect to the surface of the display screen. In addition, the electronic device in the embodiment of the disclosure further has an image acquisition apparatus. With reference to FIG. 7, the electronic device in the embodiment of the disclosure further includes:

a first obtaining unit 1, configured to obtain parameter information of the operator located in the front of the display screen by using the image acquisition apparatus, where the parameter information is used to construct a first digital image corresponding to the operator located in the front of the display screen;

a second obtaining unit 2, configured to perform a calculation using a predetermined algorithm on the parameter information to obtain a first digital image, where the first digital image is used to determine an input operation of the operator, and the first digital image matches with the first virtual image; and

a determining unit 3, configured to determine a first instruction corresponding to a first input operation based on the first digital image when the operator performs the first input operation, and present an action of the operator for performing the first input operation by the first virtual image.

In the case that the first virtual image space includes M virtual objects having one-to-one correspondence with M real objects in the environmental space, and M is an integer greater than or equal to 1, the electronic device further includes:

a processor 802, connected to the display unit and configured to construct N display objects, where N is an integer greater than or equal to 1. The processor 802 is also configured to display the N display objects on the display screen and integrate the N display objects into the virtual image space, such that an observer of the electronic device determines that the environmental space includes M+N real objects based on a display effect of the display screen.

Furthermore, in the embodiment of the disclosure, the electronic also includes image acquisition apparatus 803.

The image acquisition apparatus 803 is connected to the processor 802 and configured to obtain at least one parameter of the environmental space before the N display objects are constructed and transmit the at least one parameter to the processor.

The processor 802 is also configured to perform a predetermined algorithm for the at least one parameter to obtain a digital space, where the digital space is consistent with the virtual image space.

Furthermore, in the embodiment of the disclosure, the processor 802 is also configured to:

determine the N display objects and N positions of the N display positions in the digital space based on the digital space;

determine N display positions on the display screen corresponding to the N positions in the digital space and N display modes; and

display the N display objects on the N display positions on the display screen in the N display modes.

In the case that at least one of the M real objects is a real moving object, the digital space includes at least one operator corresponding to the at least one real moving object. The image acquisition apparatus 803 is configured to obtain a moving parameter of the at least one real moving object after a predetermined algorithm for the at least one parameter is performed to obtain a digital space, and transmit the moving parameter to the processor 802.

Furthermore, the processor 802 is also configured to:

dispose the N display objects at N new positions in the digital space based on the input operation, after determining the input operation performed by the operator based on the at least one operating position.

One or more technical solutions in the embodiments of the disclosure described above at least have one or more of the following technical effects:

in the technical solutions of the disclosure, the display screen displays the virtual image space of the environmental space in front of the display screen based on a physical imaging principle, with the virtual image space and the environmental space being symmetrical with respect to the display screen, and an observer can view M virtual objects having one-to-one correspondence with M real objects in the environmental space by the display screen. In addition, the electronic device constructs N display objects and displays the N display objects on the display screen, and the N display objects are integrated into the virtual image space, such that the observer views that the environmental space includes M+N real objects based on a display effect of the display screen, thereby combining the mirror with the display screen together; and in the case of displaying, the N display objects are cooperated with the virtual image space, such that the observer views that the environmental space includes M+N real objects based on the virtual image and the content displayed by the display screen. It is provided a new user experience according to the solution.

It should be known by those skilled in the art that the embodiments of the disclosure may be provided as a method, a system or a computer program product. Therefore, a complete hardware embodiment, a complete software embodiment or an embodiment in which hardware is combined with software may be used by the disclosure. Also, a computer program product embodied on one or more computer-usable storage mediums (including but not limited to a disk memory, a CD-ROM, an optical storage and so on) including a computer-usable program code may be used by the disclosure.

The disclosure is described with reference to the flow diagram and/or a block diagram of the method, the device (the system) and the computer program product according to the embodiments of the disclosure. It should be understood that each flow in the flow diagram and/or each block in the block diagram, or a combination of flows and/or blocks in the flow diagram and/or the block diagram may be realized by a computer program instruction. The computer program instruction may be provided to a general-purpose computer, a special-purpose computer, an embedded processor or a processor of other programmable data processing device to produce a machine, so that an instruction executed by the computer or the processor of other programmable data processing device produces an apparatus for realizing a function specified in one or more flows in the flow diagram and/or one or more blocks in the block diagram.

The computer program instruction may be stored in a computer-readable storage which can direct the computer or other programmable data processing device to work in a particular manner, so that the instruction stored in the computer-readable storage produces a manufactured product including an instruction apparatus, the instruction apparatus realizes a function specified in one or more flows in the flow diagram and/or one ore more blocks in the block diagram.

The computer program instruction may also be loaded into the computer or other programmable data processing device, so that a series of operation steps are executed on the computer or other programmable device, to produce a process realized by the computer, therefore, the instruction executed on the computer or other programmable device provides steps for realizing a function specified in one or more flows in the flow diagram and/or one ore more blocks in the block diagram.

Specifically, the computer program instructions corresponding to the two information processing method in the embodiments of the disclosure may be stored in a storage medium such as a compact disk, a hard disc or a USB flash disk, when a computer program instruction in the storage medium corresponding to the first information processing method is read or executed by the electronic device, the method for processing information includes:

obtaining parameter information of the operator located in the front of the display screen by using the image acquisition apparatus, where the parameter information is used to construct a first digital image corresponding to the operator located in the front of the display screen;

performing a calculation using a predetermined algorithm on the parameter information to obtain a first digital image, where the first digital image is used to determine an input operation of the operator, and the first digital image matches with the first virtual image; and

determining, based on the first digital image, a first instruction corresponding to a first input operation when the operator performs the first input operation, and presenting an action of the operator for performing the first input operation by the first virtual image.

Optionally, some additional computer instructions are also stored in the storage medium, the computer instructions are executed after the step of determining, based on the first digital image, a first instruction corresponding to a first input operation when the operator performs the first input operation, and presenting an action of the operator for performing the first input operation by the first virtual image, when the computer instructions are executed, the information processing method includes:

displaying a first display content on the display screen; and

controlling the display screen to display a second display content different from the first display content in response to a first instruction and based on the first instruction.

Optionally, some additional computer instructions are also stored in the storage medium, the computer instructions are executed after the step of the determining, based on the first digital image, a first instruction corresponding to a first input operation when the operator performs the first input operation, and presenting an action of the operator for performing the first input operation by the first virtual image, or the controlling the display screen to display a second display content different from the first display content in response to the first instruction and based on the first instruction, when the computer instructions are executed, the information processing method includes:

determining whether the first input operation meets a first preset condition, to obtain a first determining result; and

controlling the display screen to display a first part of the first digital image in the case that the first determining result indicates that the first input operation meets the first preset condition.

Optionally, in a process of executing the computer instruction stored in the storage medium corresponding to the step of performing a calculation using a predetermined algorithm on the parameter information to obtain the first digital image, the method for processing information includes:

obtaining at least one first coordinate of a display content on the display screen in an eye coordinate system based on the parameter information;

obtaining information on a first position of eyes of a user based on the parameter information; and

performing a first calculation based on the information of the first position and the at least one first coordinate, to obtain the first digital image.

Optionally, in a process of executing the computer instruction stored in the storage medium corresponding to the step of performing a first calculation on the information on a first position and the at least one first coordinate to obtain the first digital image, the method for processing information includes:

constructing a homography of the coordinate system of the display screen corresponding to the eye coordinate system based on the information of the first position;

obtaining at least one second coordinate of the display content in the display plane coordinate system based on the at least one first coordinate and the homography; and

obtaining the first digital image based on the at least one second coordinate.

Obviously, various modifications and variations can be made to the disclosure by those skilled in the art without departing from the sprit and scope of the disclosure. In this way, provided that these modifications and variations to the disclosure fall within the scope of the claims of the disclosure and the equivalents thereof, the disclosure intends to include these modifications and variations.

What is claimed is:

1. A method for processing information, comprising:
obtaining parameter information of an operator located in the front of a mirror display screen by using an image acquisition apparatus;
calculating a first digital image matching with a virtual image of the operator based on the parameter information by using a predetermined algorithm; and
determining, based on the first digital image, a first instruction corresponding to a first input operation performed by the operator.

2. The method according to claim 1, wherein after determining, based on the first digital image, a first instruction corresponding to a first input operation performed by the operator, the method further comprises:
displaying a first display content on the display screen; and
controlling the display screen to display a second display content different from the first display content in response to the first instruction and based on the first instruction.

3. The method according to claim 1, wherein after determining, based on the first digital image, a first instruction corresponding to a first input operation performed by the operator, the method further comprises:
judging whether the first input operation meets a first preset condition, to obtain a first judging result; and
controlling the display screen to display a first part of the first digital image in the case that the first judging result indicates that the first input operation meets the first preset condition.

4. The method according to claim 3, wherein calculating a first digital image based on the parameter information by using a predetermined algorithm comprises:
obtaining at least one first coordinate of a display content on the display screen in a coordinate system of eyes based on the parameter information;
obtaining information on a first position of the eyes based on the parameter information; and
calculating the first digital image based on the information of the first position and the at least one first coordinate.

5. The method according to claim 4, wherein calculating the first digital image based on the information of the first position and the at least one first coordinate comprises:
constructing a homography of a coordinate system of a display plane of the display screen corresponding to the coordinate system of the eyes based on the information of the first position;
obtaining at least one second coordinate of the display content in the coordinate system of the display plane based on the at least one first coordinate and the homography; and
obtaining the first digital image based on the at least one second coordinate of the display content.

6. The method according to claim 1, wherein in the case that the first virtual image contains at least one virtual object having one-to-one corresponding to at least one real object in an environmental space where the operator is located, the method further comprises:
constructing at least one display object;
displaying the display object on the display screen.

7. The method according to claim 6, wherein before constructing at least one display object, the method further comprises:
obtaining at least one parameter of the environment space via the image acquisition apparatus;
performing a predetermined algorithm on the at least one parameter to obtain a digital space, wherein the digital space is consistent with a virtual image space which is symmetrical to the environment space with respect to the display screen.

8. The method according to claim 7, wherein displaying the display object on the display screen comprises:
determining the at least one display object and at least one position of the display object in the digital space based on the digital space;
determining at least one display position on the display screen corresponding to the at least one position in the digital space; and
displaying the display object at the display position on the display screen.

9. The method according to claim 7, further comprising:
obtaining a moving parameter of the operator via the image acquisition apparatus;
determining an operating position of the operator in the digital space based on the digital space and the moving parameter; and
determining an input operation performed by the operator for the display object based on the operating position.

10. The method according to claim 9, wherein after determining an input operation performed by the operator for the display object based on the operating position, the method further comprises:
disposing the display object at a new position based on the input operation.

11. An electronic device comprising a display screen comprising a mirror display screen, wherein the electronic device further comprises:
a first obtaining unit, configured to obtain parameter information of an operator located in the front of the display screen by using an image acquisition apparatus;
a second obtaining unit, configured to calculate a first digital image matching with a virtual image of the operator based on the parameter information by using a predetermined algorithm; and
a determining unit, configured to determine a first instruction corresponding to a first input operation performed by the operator based on the first digital image.

12. The electronic device according to claim 11, further comprising:
a display unit, configured to display a first display content, and display a second content different from the first display content in response to the first instruction and based on the first instruction.

13. The electronic device according to claim 11, further comprising:
a first judging unit, configured to judge whether the first input operation meets a first preset condition, to obtain a first judging result; and
a controlling unit, configured to control the display screen to display a first part of the first digital image in the case that the first judging result indicates that the first input operation meets the first preset condition.

14. The electronic device according to claim 13, wherein the second obtaining unit comprises:
a first obtaining module, configured to obtain at least one first coordinate of a display content on the display screen in a coordinate system of eyes based on the parameter information;
a second obtaining module, configured to obtain information on a first position of the eyes based on the parameter information; and
a third obtaining module, configured to calculate the first digital image based on the information of the first position and the at least one first coordinate.

15. The electronic device according to claim 14, wherein the third obtaining module is configured to:
construct a homography of a coordinate system of a display plane of the display screen corresponding to the coordinate system of the eyes based on the information of the first position;
obtain at least one second coordinate of the display content in the coordinate system of the display plane based on the at least one first coordinate and the homography; and
obtain the first digital image based on the at least one second coordinate of the display content.

16. The electronic device according to claim 12, wherein in the case that the first virtual image contains at least one virtual object having one-to-one corresponding to at least one real object in an environmental space where the operator is located, the electronic device further comprises:
a processor, connected to the display screen, and configured to construct at least one display object, and control the display screen to display the display object.

17. The electronic device according to claim 16, wherein the first obtaining unit is connected to the processor, configured to obtain at least one parameter of the environment space and send the at least one parameter of the environment space to the processor before constructing the display object;
the processor is configured to perform predetermined algorithm on the at least one parameter to obtain a digital space, wherein the digital space is consistent with a virtual image space which is symmetrical to the environment space with respect to the display screen.

18. The electronic device according to claim 17, wherein the processor is further configured to:
determine the at least one display object and at least one position of the display object in the digital space based on the digital space;
determine at least one display position on the display screen corresponding to the at least one position in the digital space; and
control the display screen to display the display object at the display position.

19. The electronic device according to claim 17, wherein the processor is configured to:
obtain a moving parameter of the operator via the image acquisition apparatus;
determine an operating position of the operator in the digital space based on the digital space and the moving parameter; and
determine an input operation performed by the operator for the display object based on the operating position.

20. The electronic device according to claim 19, wherein the processor is configured to dispose the display object at a new position based on the input operation after determining the input operation performed by the operator for the display object based on the operating position.
